(19) United States
(12) Patent Application Publication
(10) Pub. No.: US 2003/0154097 A1
(43) Pub. Date: Aug. 14, 2003

(54) Methods and systems for managing personal needs

(75) Inventors: Jay Hartley, Newtown, CT (US); Gary J. Guiser, Norwalk, CT (US)

Correspondence Address: LAW OFFICE OF BARRY R LIPSITZ, 755 MAIN STREET, MONROE, CT, 06468, US

(73) Assignee: LifeCare, Inc., Westport, CT

(21) Appl. No.: 10/360,060

(22) Filed: Feb. 6, 2003

Related U.S. Application Data
(60) Provisional application No. 60/357,444, filed on Feb. 14, 2002.

(51) Int. Cl. G06F 17/60

(52) U.S. Cl. 705/1; 705/2

(57) ABSTRACT

Methods and systems for managing personal needs are provided. In particular, the present invention relates to an personal assistance program enabled via a communication network. An individual's needs are fulfilled via a customized Resource Center created in response to the individual's inquiry. The Resource Center may be in the form of a personalized web page created for the individual by a specialist in response to the inquiry. The Resource Center may contain specific educational materials relating to the particular need in question, as well as personalized referral information relating to providers qualified by the specialist for the individual. The specialists are provided to assist individuals with virtually all aspects of daily life, including but not limited to child care, pet care, education, employee benefits, health care, elder care, pregnancy, finance, personal problem solving, time management, or the like.

This application claims the benefit of U.S. provisional patent application No. 60/357,444 filed on Feb. 14, 2002, which is incorporated herein and made a part hereof by reference.

### BACKGROUND OF THE INVENTION

The present invention relates to methods and systems for managing personal needs. In particular, the present invention relates to a personal assistance program enabled via a communication network which provides personalized information and referrals relating to an individual's specific personal need.

As the demands of daily life continue to increase, employers have begun offering personal assistance services to their employees in order to increase productivity, retain employees, decrease absenteeism, and improve the health and morale of employees. For example, many employers provide employees with access to Employee Assistance Providers (EAPs). An EAP may provide benefits information, health and wellness information, and other services to an employee. Employers may also offer referral services to an employee. Such referral services may relate to a wide variety of employee needs, including child care, health care, retirement, benefits, education, pet care, relocation, legal assistance, financial planning, or the like.

It would be advantageous to integrate the services traditionally provided by an employers' human resource department with the services offered by EAPs and other third party providers into a single system. It would be further advantageous to deliver the services via a centralized center which can deliver information and referrals specifically tailored to an individual's personal needs via a communications network.

The methods and systems of the present invention provide the foregoing and other advantages.

### SUMMARY OF THE INVENTION

The present invention relates to a system for managing personal needs, and is referred to by the Assignee of the present invention as its “Life Event Management^{SM}” services. In particular, the present invention relates to a personal assistance program enabled via a communication network. In an example embodiment, the personal assistance program may be provided by an employer to its employees. An employee's needs are fulfilled via a customized Resource Center created in response to the employee's inquiry. The Resource Center may be in the form of a customized web page created for the employee by a specialist in response to the employee's inquiry. The Resource Center may contain specific educational materials relating to the need in question, as well as personalized referral information. The specialists are enabled to assist employees with virtually all aspects of daily life, including but not limited to child care, pet care, education, employee benefits, health care (including children's health, diet and nutrition, fitness, general health, men's health, safety and health, senior health, women's health, workplace health, or the like), elder care, pregnancy, prenatal care, finance, personal problem solving, time management, or the like.

The employee (or a dependent or beneficiary of the employee, if authorized) can obtain assistance from work or home via professionally staffed client call centers and/or a specialized web site 24 hours a day, seven days a week. The present invention enables the specialists to thoroughly assess an employee's needs and immediately respond to the employee by providing instant access to relevant educational materials. This is followed up with highly personalized provider and resource referrals. Upon receiving an employee's request, the specialist immediately sends educational materials (e.g., via a hyperlink in an email) that help to inform the employee about available options. More personalized information is sent one to five days later containing additional, more specialized, educational materials, together with customized referral information.

The management system of the present invention is described herein as an employee assistance tool which can be offered by employers to their employees. However, those skilled in the art will appreciate that such a system may be offered to individuals directly by a service provider for a fee, or by other entities, such as an individual's insurance company, an Employee Assistance Provider (EAP), a health and wellness vendor, or the like.

The present invention enables employers to operate more efficiently and realize cost savings. For example, the present invention will result in increased employee productivity by decreasing absenteeism through preventative measures and increased utilization of benefits available to the employee. Absenteeism will also be reduced as the invention provides a single point of contact for an employee as well as more efficient benefits communication.

Human resource and administrative costs will be reduced via the present invention. For example, the present invention eliminates redundancy of services across multiple vendors. The entire health management offerings of a company may be managed within a single group. Several corporate budgets may be consolidated under a new, single program. Human resource time spent answering employee's questions will be reduced. Personal needs and EAP usage data can be collected in one location to identify trends and manage strategic benefits costs.

Medical costs of the employer may be reduced, as the invention will impact the medical cost trend by decreasing employees' risk profiles and by enabling implementation of demand management and disease management programs.

Employee morale and attrition rates will be reduced due to a comprehensive benefits program provided by the present system.

Corresponding methods and systems are provided having the foregoing benefits and advantages.

### BRIEF DESCRIPTION OF THE DRAWINGS

The present invention will hereinafter be described in conjunction with the appended drawing figures, wherein like numerals denote like elements, and:

FIG. 1 shows a block diagram of an example embodiment of the invention;

FIG. 2 shows a flowchart of a further example embodiment of the invention;

FIG. 3 shows an example web page illustrating an example of a personalized Resource Center Home Page;

FIG. 4 shows an example web page containing hyperlinks to educational materials which can be accessed from the personalized Resource Center Home Page;

FIG. 5 shows an example web page showing hyperlinks to referral information and related educational materials which can be accessed via the personalized Resource Center Home Page; and

FIG. 6 shows an example web page containing a quality assurance questionnaire.

### DETAILED DESCRIPTION OF THE INVENTION

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing a preferred embodiment of the invention. It should be understood that various changes may be made in the function and arrangement of elements without departing from the spirit and scope of the invention as set forth in the appended claims.

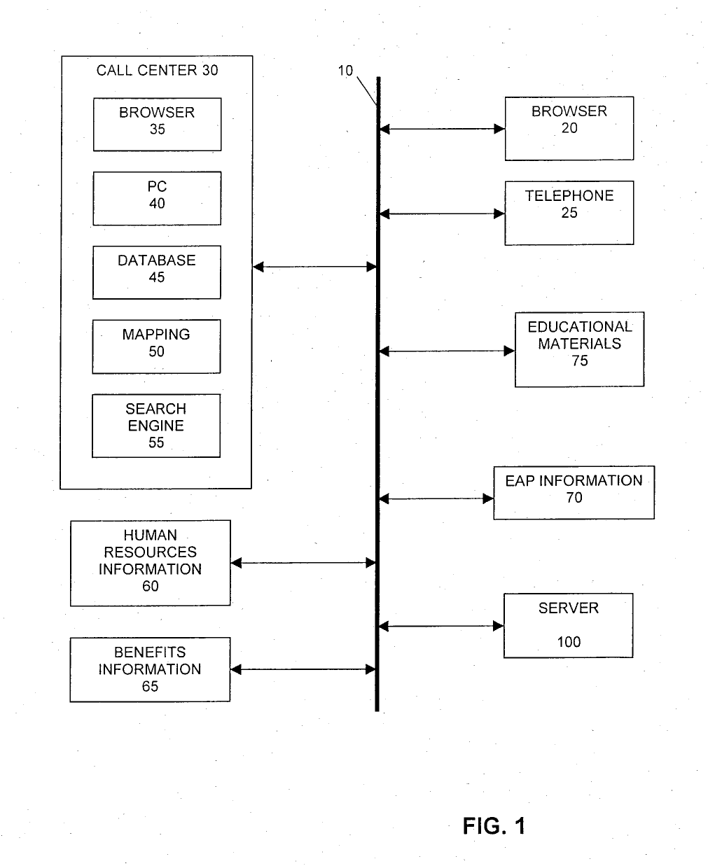

The present invention provides methods and systems for managing personal needs of an individual. In an example embodiment of the invention as shown in FIG. 1, a communication network 10 adapted to enable a specialist (e.g., at call center 30) to receive a request from an individual for assistance regarding a personal need is provided. Means (e.g., a personal computer 40) are provided for creating a personalized web page in response to the request. The personalized web page may comprise hyperlinks to at least one of educational materials or referral information relating to the personal need. Means (e.g., a browser 35) are provided for communicating a first hyperlink to the personalized web page to the individual. The user can then receive the communication containing the hyperlink at a browser 20 and view the personalized web page. The personalized web page is also referred to herein as the “Resource Center”.

The request for assistance may comprise one of a telephone request via telephone 25 or an online request via browser 20. In the event the request for assistance is made via telephone, an operator at the call center 30 may verify the individual's eligibility to access the specialist. If eligibility is verified, the operator will assign the individual to a specialist based on the personal need.

The communication network 10 may comprise one or more of a telephone network, an intranet, the Internet, a local area network, a wide area network, a global network, or the like.

The means 40 for creating the personalized web page and the means 35 for communicating the first hyperlink to the individual may be operated by the specialist. The specialist may be one of many specialists at a central call center 30 and each specialist may have a different area of expertise.

Eligibility of the individual to access the system may be verified before access to the system is granted. For example, the individual may be asked for identifying information which can be compared against records maintained at the call center 30. Identifying information may include one or more of the individual's social security number, an employee identification number, a password, an insurance policy identification number, or the like.

The system may also include at least one of an informational database 45, geographic mapping software 50, or an online search engine 55 adapted for use by the specialist during the qualifying of the at least one potential provider, creating the personalized web page, or updating of the personalized web page. Although the informational database 45, mapping software 50, and search engine 55 are shown in FIG. 1 as part of the call center 30, those skilled in the art will appreciate that these functions may be implemented as separate applications provided outside of the call center and accessed via the network 10 via a server 100.

The specialist may conduct an intake interview with the individual regarding the personal need prior to creating the personalized web page. The specialist may use at least one of the informational database 45 or geographic mapping software 50 during the intake interview. The database 45 may contain the individual's employment history, personnel records regarding the individual, insurance records, health records, benefits records, details of past calls to the call center, details regarding the individual's family, or the like. The mapping software 50 enables the specialist to quickly determine the individual's location or commute route to better understand geographical search requirements so that, for example, providers near the individual's location or commute may be found and qualified.

After the educational materials are provided to the individual via the first hyperlink, the specialist may then qualify at least one potential provider for the individual based on the intake interview. The personalized web page may then be updated to include hyperlinks to referral information for the at least one qualified provider. A second hyperlink to the updated personalized web page can then be communicated to the individual.

The referral information provided for each provider may comprise at least one of a listing of goods or services provided by the provider, provider program and service information relating to the personal need, costs of the provider programs, provider contact information, provider location, directions to the provider, availability of the provider, licensing of the provider, qualifications of the provider, or the like. Examples of providers which may be qualified by the specialist include physicians, pediatricians, psychologists, optometrists, health care facilities, rehabilitation facilities, nursing facilities, specialized medical facilities, chiropractors, exercise facilities, nursing homes, medical equipment retailers, child care facilities, baby sitters, veterinarians, kennels, health insurance providers, attorneys, financial services, retirement services, educational facilities, retail stores, food service facilities, or the like. Those skilled in the art will appreciate that the present invention may be extended to qualify virtually any provider of goods and/or services.

The personalized web page may be available to the individual for a predetermined amount of time. Information may be removed from the web page or the web page may be removed from the server so that only up-to-date information is provided to the individual.

In an example embodiment, the personalized web page may comprise a secure and confidential web page. Access to the secure and confidential web page may be enabled via a password (or other confidential registration and/or access methods).

The password may be communicated to the individual for accessing the secure and confidential web page by a variety of means, including by telephone, email, facsimile, or the like.

At least one additional hyperlink to a quality assurance questionnaire may be provided on the personalized web page. The quality assurance questionnaire asks the individuals to provide feedback on the services provided, including the quality of the educational materials, referrals, specialists, or the like. The quality assurance questionnaire may also be emailed to the individual if a completed questionnaire is not received within a predetermined period of time. Where the services are provided as part of an employee assistance program, copies of completed questionnaires may be provided to the employers to enable continued enhancement of the services provided.

The specialist may follow up with the individual within a predetermined period of time after the first hyperlink to the personalized web page is communicated. The follow up may be by email or telephone. During the follow up, the specialist will check on the individual's progress and offer additional assistance.

An agreement to a waiver by the individual may be required prior to accessing the personalized web page. The waiver language holds the system operator and the employer harmless from issues arising from referred providers or resources.

The personal need may relate to at least one of child care, children with special needs, pet care, education, employee benefits, health care, children's health, diet and nutrition, employer policies and procedures, employer benefits, insurance, insurance claims, mental health, fitness, general health, men's health, safety and health, senior health, women's health, workplace health, elder care, pregnancy, prenatal care, legal services, finance, personal problem solving, time management, or the like.

In an example embodiment of the invention, the individual may be one of an employee or a dependent of an employee. As shown in FIG. 1, the specialist may have access to an employer's human resource information 60 and benefits information 65 regarding the employee. In addition, the specialist may have access to the employer's Employee Assistance Provider (EAP) information 70. The referral information may include EAP information.

Utilization reports may be provided to the employer regarding requests for assistance received. The reports may be customized for the specific needs of the employer.

The personalized web page may be updated to include at least one of status information regarding the request or employer personnel policy and benefits information relating to the personal need. A second hyperlink to the updated personalized web page is then communicated to the individual. The status information may include at least one of status of a request for information, status of a claim relating to the personal need, status of a response to a request for benefits relating to the personal need, status of a product order relating to the personal need, or the like. The employer personnel policy and benefits information may include at least one of a statement of corporate policy relating to the personal need, a description of the employee's health insurance plan, a description of the employee's dental insurance plan, a description of the employee's vision insurance plan, a description of the employer's Employee Assistance Program, a description of the employee's mental health insurance plan, a summary of authorization requirements for insurance plans, a description of the employee's retirement plan, a description of the employer's financial programs, or the like.

The individual may also be one of a care recipient, a care provider, or a beneficiary of a care recipient. In such an embodiment, the specialist may have access to at least one of the care recipient's insurance information, the care recipient's medical records, the care recipient's employee benefits information, the care provider's policies and procedures, the care provider's care program information, or the like.

Alternatively, the individual may be one of a customer or a service provider. In such an embodiment, the specialist may have access to the customer's service request records, the service provider's policies and procedures, the service provider's service information, and the like.

In a further example embodiment of the invention, the educational materials may be provided in the form of an online library 75. The educational materials may comprise at least one of state regulations relating to the personal need, publications relating to the personal need, web pages relating to the personal need, product information relating to the personal need, Employee Assistance Provider information relating to the personal need, employee benefits information relating to the personal need, employer policy and procedural information relating to the personal need, insurance information relating to the personal need, claim information relating to the personal need, on-line seminar information, decision support tools and calculators.

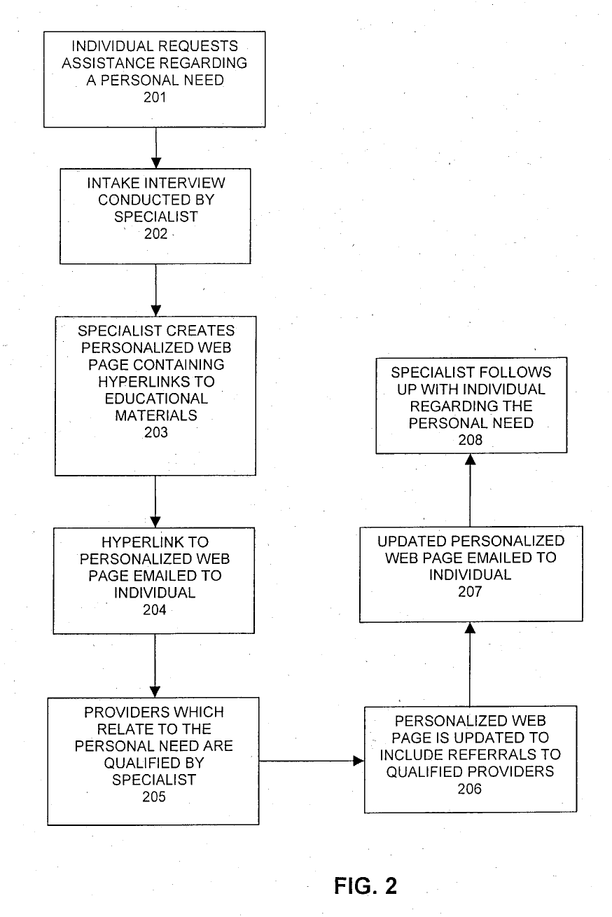

FIG. 2 shows a flowchart of an example of a case process that may be implemented in accordance with the present invention. The following example assumes that the system is provided by an employer to employees as part of an employee assistance program.

Employee Contacts System Operator and is Connected to a Work/Life Specialist.

As shown by Box 201, an employee calls a call center to request assistance regarding a personal need. A call center operator asks for the employee's company name and Social Security number (or other company-designated ID number or similar information) to verify eligibility. Next, the operator inquires about the employee's specific personal needs and then connects the employee with a specialist who can best assist the employee. The assigned specialist works with the employee on a one-on-one basis throughout the entire case process, no matter how long it takes. Multilingual specialists and/or the AT&T Language Line (or the like) are used to serve non-English-speaking employees.

It is recommended that clients (i.e. employers) provide eligibility data/files so that the most personalized services can be offered to employers and employees in the shortest time possible. In addition, employees will be provided with instant access to educational materials, the ability to retrieve personalized referrals online, and other online personalization features (as described below). Employers may also be provided with detailed, customized utilization reports.

Specialist Conducts Thorough Needs Assessment with Employee.

As shown at box 202, the specialists conduct a comprehensive intake interview and needs assessment with each employee to understand their specific situation and needs in terms of services, budget, location requirements, special concerns, requests, or the like. The specialists do not use a script, but rather the database, online search engine and mapping technology enables them to ask the right questions as the conversation progresses. At the same time, specialists confidentially document information in the system so employees never have to repeat themselves.

Specialist Immediately Delivers Pertinent Educational Information.

As shown at box 203, after reviewing all of the available options with the employee, the specialist creates a personalized web page containing hyperlinks to educational materials regarding the personal need. As shown at box 204, the specialist may then e-mail the employee hyperlinks to the personalized web page, which contains hyperlinks to educational materials. The personalized web page may be contained in a personalized, private area of the system's web site called the “Resource Center.” (If the employees do not have e-mail or Internet access, or their companies do not provide eligibility information, information may be sent via conventional mail.) The employee is encouraged to review this information while the specialist qualifies potential providers and creates referrals to providers who best meet the employee's specific needs.

The specialist will explain to the employee that educational materials are available immediately but that the referral research process typically takes one to five days in order to fully qualify each provider. Before ending the initial conversation, the specialist will review other company benefits available to the employee (which information may be housed in the case management systems available to the specialist), along with relevant resources. For example, if the employee requires additional assistance from an EAP or another benefits provider, the specialist would refer the employee to the appropriate contact or connect the employee directly via warm telephone transfer.

Specialist Qualifies Potential Providers.

As shown at box 205, after e-mailing relevant educational materials to the employee, the specialist uses a comprehensive database to identify appropriate care providers and resources according to each employee's specifications (budget, location, etc.). Mapping software helps the specialist identify appropriate, conveniently located providers no matter where an employee lives. Rather than just sending the employee a listing of local providers, the specialist can call each potential provider and ask a series of questions (regarding availability, cost, services, licensing requirements, etc.) to determine which providers most closely match the employee's needs. For example, if an employee requests a child care center that costs less than $250 a week, the specialist will not refer a center that charges $350 a week. By extensively qualifying providers, the specialist helps the employee narrow the employee's search and saves hours of employee research that would typically be conducted during regular business hours, when most providers are open. After the specialist has prescreened and qualified appropriate providers, the specialist creates referrals detailing the programs and case-specific information for the employee.

Referrals are Delivered to the Employee.

As shown at box 206, the specialist updates the Resource Center web page to include the referrals to qualified providers. As shown at box 207, for optimum convenience, speed and efficiency, the specialist sends an e-mail link that takes the employee directly to the updated Resource Center web page, where they can confidentially retrieve personalized referrals and related educational resources for a predefined period of time (e.g., up to 30 days). Information may be removed after the predefined time period to ensure that the employee has only the most up-to-date information at all times. For employees without e-mail or Internet access (or for those clients who have not provided eligibility data), specialists can send information via fax or first class mail. Specialists also can arrange for providers to send additional information to employees by e-mail or regular mail.

Before accessing their personalized web page in the Resource Center, employees may be required to agree to waiver language that holds the system operator and the employer harmless from issues arising from referred providers or resources.

Employees can rate the services provided through a Quality Assurance Questionnaire, which may be located prominently in the Resource Center. This questionnaire asks employees to provide feedback on the system operator's services including the quality of their educational materials, referrals, specialist, or the like. To maximize return rates, a copy of the questionnaire is e-mailed to employees if a completed one has not been received within a predetermined period of time. (All materials sent by conventional mail are accompanied by a hard copy waiver letter and a Quality Assurance Questionnaire.) Feedback from this questionnaire is used to continually enhance the services, and copies (coded for confidentiality) are sent to the employer.

Specialist Follows up with Employee.

As shown at box 208, the specialist follows up with the employee at a prearranged date and time (for example, two weeks after information is sent) by e-mail or telephone, depending upon employee preferences. During this follow up, the specialist checks on the employee's progress and offers additional assistance. Employees are encouraged to contact their specialists as often as needed.

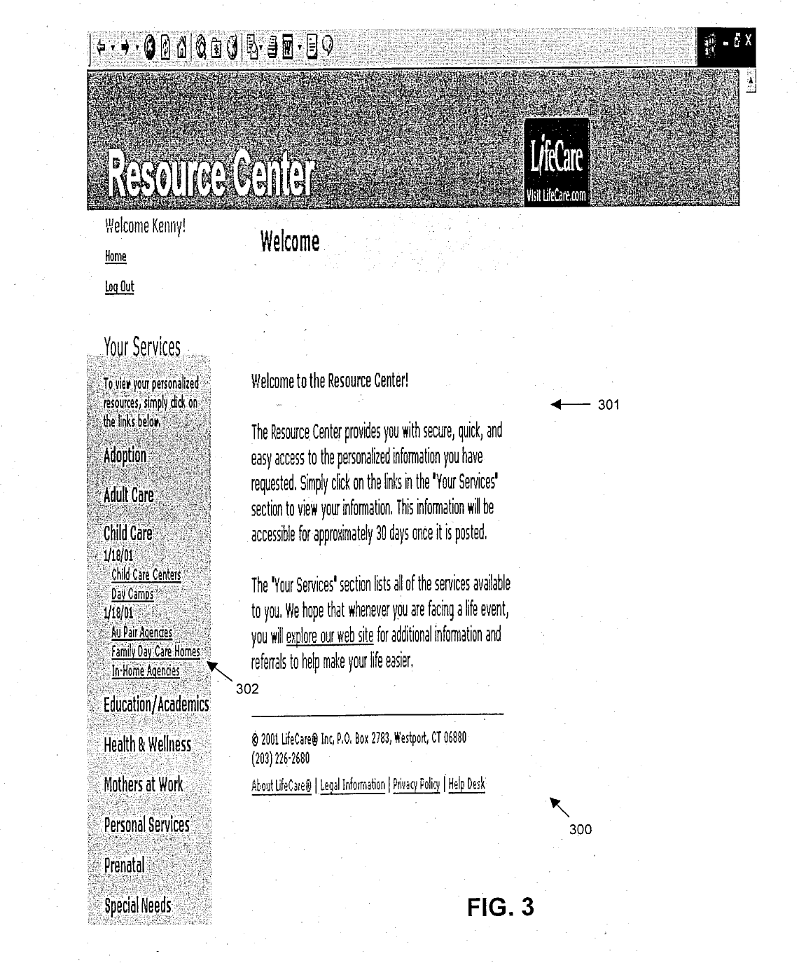

FIGS. 3-6 show example web pages which may be generated by the specialist in response to the request for assistance. As discussed above, upon receiving a request for assistance, the specialist may email a hyperlink to a customized web page, such as web page 300 shown on FIG. 3. This web page may comprise a home page for the individual's personalized “Resource Center”, which includes a welcome message 301 and hyperlinks 302 relating to the individuals request(s) for assistance. The hyperlinks 302 shown in FIG. 3 include a child care center link, a day care center link, an au pair agency link, a family day care homes link, and an in-home agencies link.

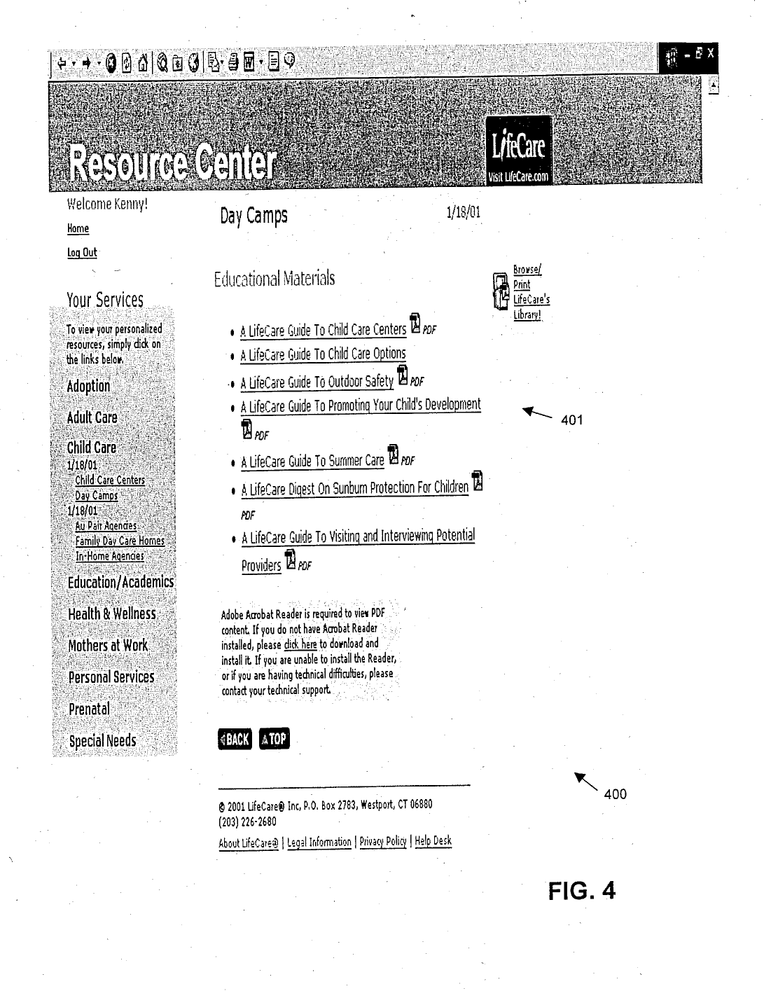

FIG. 4 shows an example web page 400 containing educational materials which can be accessed from the employee's personalized Resource Center Home Page shown in FIG. 3. For example, by clicking on the day camps link 304 of FIG. 3, the employee can access links to educational materials 401 relating to day camps as shown on FIG. 4.

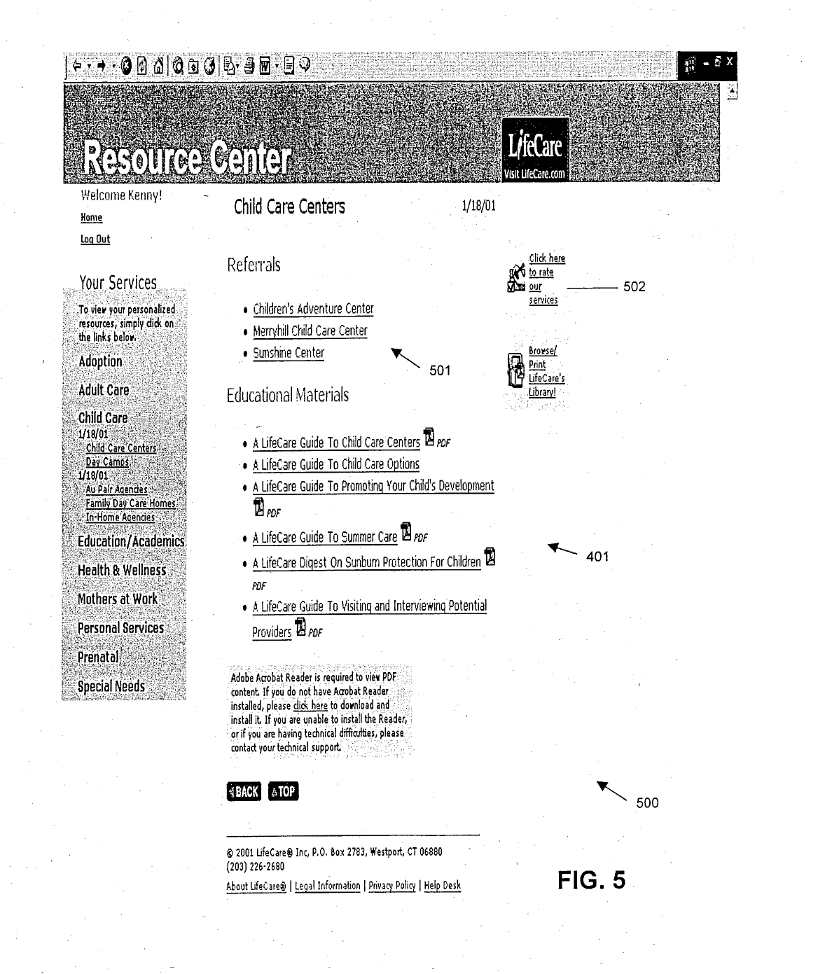

As shown in FIG. 5, the web page 400 of FIG. 4 may be updated to include hyperlinks 501 to provider referral information once the providers are qualified by the specialist as discussed above. The web page 500 shown on FIG. 5 also contains a link to a quality assurance questionnaire 502.

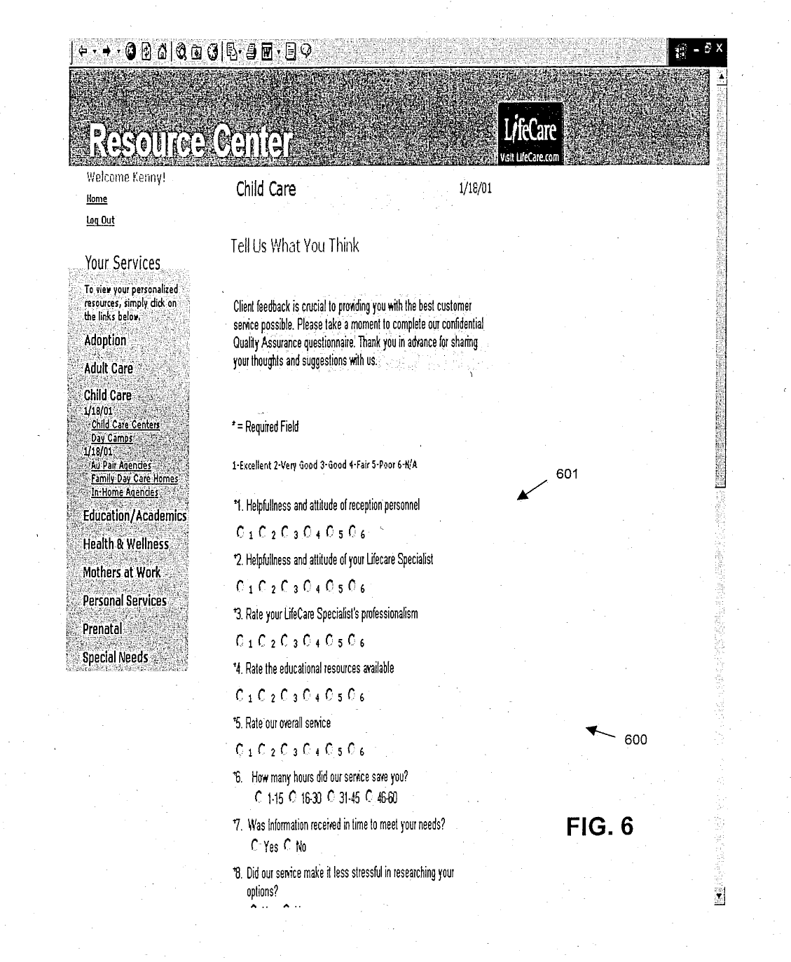

FIG. 6 shows an example web page 600 containing the quality assurance questionnaire which may accessed via link 502 of FIG. 5. The quality assurance questionnaire may include a list of questions 601 relating to the services provided. It should now be appreciated that the present invention provides advantageous methods and systems for managing personal needs. In the illustrated implementation, employee satisfaction and efficiency is improved by providing a system to assist employees with personal tasks that would otherwise consume valuable time during working hours.

Although the invention has been described in connection with various illustrated embodiments, numerous modifications and adaptations may be made thereto without departing from the spirit and scope of the invention as set forth in the claims.

What is claimed is:

1. A method for managing personal needs, comprising the steps of:
fielding by a specialist of a request from an individual for assistance regarding a personal need;
creating a personalized web page in response to the request, said personalized web page comprising hyperlinks to at least one of educational materials or referral information relating to the personal need; and
communicating a first hyperlink to said personalized web page to said individual.

2. A method in accordance with claim 1, wherein:
said personalized web page is created by said specialist; and
said first hyperlink to said personalized web page is electronically transmitted by said specialist to said individual.

3. A method in accordance with claim 1, further comprising:
verifying eligibility of said individual to access said specialist.

4. A method in accordance with claim 1, further comprising:
conducting an intake interview with said individual regarding the personal need prior to creating said personalized web page.

5. A method in accordance with claim 4, wherein:
at least one of an informational database and geographic mapping software is used by said specialist during said intake interview.

6. A method in accordance with claim 4, wherein said personalized web page comprises said hyperlinks to educational materials, further comprising:
qualifying at least one potential provider for said individual based on said intake interview;
updating said personalized web page to include hyperlinks to referral information for said at least one qualified provider; and
communicating a second hyperlink to said updated personalized web page to said individual.

7. A method in accordance with claim 6, wherein:
at least one of an informational database, an online search engine, and geographic mapping software is used by said specialist during said qualifying of said at least one potential provider and updating of said personalized web page.

8. A method in accordance with claim 6, wherein said referral information comprises, for each provider, at least one of:
a listing of goods or services provided by the provider, provider program and service information relating to the personal need, costs of said provider programs, provider contact information, provider location, directions to said provider, availability of said provider, licensing of said provider, or qualifications of said provider.

9. A method in accordance with claim 1, wherein said personalized web page is available to said individual for a predetermined amount of time.

10. A method in accordance with claim 1, wherein:
said personalized web page comprises a secure and confidential web page; and
access to said secure and confidential web page is enabled via a password.

11. A method in accordance with claim 10, further comprising:
communicating said password to said individual for accessing said secure and confidential web page.

12. A method in accordance with claim 1, further comprising:
providing at least one additional hyperlink to a quality assurance questionnaire on said personalized web page.

13. A method in accordance with claim 1, further comprising:
following up with said individual within a predetermined period of time after said first hyperlink to said personalized web page is communicated.

14. A method in accordance with claim 1, further comprising:
requiring agreement to a waiver by said individual prior to accessing said personalized web page.

15. A method in accordance with claim 1, wherein said personal need relates to at least one of child care, children with special needs, pet care, education, employee benefits, health care, children's health, diet and nutrition, employer policies and procedures, employer benefits, insurance, insurance claims, mental health, fitness, general health, men's health, safety and health, senior health, women's health, workplace health, elder care, pregnancy, prenatal care, legal services, finance, personal problem solving, or time management.

16. A method in accordance with claim 1, wherein:
at least one of an informational database, an online search engine, or geographic mapping software is used by said specialist in creating said personalized web page.

17. A method in accordance with claim 1, wherein:
said individual is one of an employee or a dependent of an employee; and
said specialist has access to an employer's human resource information regarding said employee.

18. A method in accordance with claim 17, wherein:
said specialist has access to said employer's Employee Assistance Provider (EAP) information.

19. A method in accordance with claim 18, wherein said referral information includes EAP information.

20. A method in accordance with claim 17, further comprising:
providing utilization reports to said employer regarding requests for assistance received.

21. A method in accordance with claim 17, further comprising:
updating said personalized web page to include at least one of:
status information regarding said request; or
employer personnel policy and benefits information relating to said personal need; and
communicating a second hyperlink to said updated personalized web page to said individual.

22. A method in accordance with claim 21, wherein said status information includes at least one of status of a request for information, status of a claim relating to the personal need, status of a response to a request for benefits relating to said personal need, or status of a product order relating to said personal need.

23. A method in accordance with claim 21, wherein said employer personnel policy and benefits information includes at least one of a statement of corporate policy relating to said personal need, a description of the employee's health insurance plan, a description of the employee's dental insurance plan, a description of the employee's vision insurance plan, a description of the employer's Employee Assistance Program, a description of the employee's mental health insurance plan, a summary of authorization requirements for insurance plans, a description of the employee's retirement plan, or a description of the employer's financial programs.

24. A method in accordance with claim 1, wherein:
said individual is one of a care recipient, a care provider, or a beneficiary of a care recipient; and
said specialist has access to at least one of said care recipient's insurance information, said care recipient's medical records, said care recipient's employee benefits information, said care provider's policies and procedures, or said care provider's care program information.

25. A method in accordance with claim 1, wherein:
said individual is one of a customer or a service provider; and
said specialist has access to said customer's service request records, said service provider's policies and procedures, or said service provider's service information.

26. A method in accordance with claim 1, wherein:
said educational materials are provided in the form of an online library.

27. A method in accordance with claim 1, wherein said educational materials comprise at least one of state regulations relating to said personal need, publications relating to said personal need, web pages relating to said personal need, product information relating to said personal need, Employee Assistance Provider information relating to said personal need, employee benefits information relating to said personal need, employer policy and procedural information relating to said personal need, insurance information relating to said personal need, claim information relating to said personal need, on-line seminar information, or decision support tools and calculators.

28. A method in accordance with claim 1, wherein:
said request for assistance comprises one of a telephone request or an online request.

29. A method in accordance with claim 1, wherein:
said request for assistance is made via telephone;
an operator verifies said individual's eligibility to access said specialist; and
an operator assigns said individual to a specialist based on said personal need.

30. A system for managing personal needs, comprising:
a communication network adapted to enable a specialist to receive a request from an individual for assistance regarding a personal need; and
means for creating a personalized web page in response to the request, said personalized web page comprising hyperlinks to at least one of educational materials or referral information relating to the personal need;
means for communicating a first hyperlink to said personalized web page to said individual; and
a web browser adapted to receive said communication containing said hyperlink and to view said personalized web page.

31. A system in accordance with claim 30, wherein:
said means for creating said personalized web page is operated by said specialist; and
said means for communicating said first hyperlink to said personalized web page to said individual is operated by said specialist.

32. A system in accordance with claim 30, wherein:
eligibility of said individual to access said system is verified.

33. A system in accordance with claim 30, wherein:
an intake interview with said individual is conducted regarding the personal need prior to creating said personalized web page.

34. A system in accordance with claim 33, further comprising:
at least one of an informational database or geographic mapping software adapted for use by said specialist during said intake interview.

35. A system in accordance with claim 33, wherein:
said personalized web page comprises said hyperlinks to educational materials;
at least one potential provider for said individual is qualified based on said intake interview;
said personalized web page is updated to include hyperlinks to referral information for said at least one qualified provider; and
a second hyperlink to said updated personalized web page is communicated to said individual.

36. A system in accordance with claim 35, further comprising:
at least one of an informational database, an online search engine, or geographic mapping software adapted for use by said specialist during said qualifying of said at least one potential provider and updating of said personalized web page.

37. A system in accordance with claim 35, wherein said referral information comprises, for each provider, at least one of:
a listing of goods or services provided by the provider, provider program and service information relating to the personal need, costs of said provider programs, provider contact information, provider location, directions to said provider, availability of said provider, licensing of said provider, or qualifications of said provider.

38. A system in accordance with claim 30, wherein said personalized web page is available to said individual for a predetermined amount of time.

39. A system in accordance with claim 30, wherein:
said personalized web page comprises a secure and confidential web page; and
access to said secure and confidential web page is enabled via a password.

40. A system in accordance with claim 39, wherein:
said password is communicated to said individual for accessing said secure and confidential web page.

41. A system in accordance with claim 30, wherein:
at least one additional hyperlink to a quality assurance questionnaire is provided on said personalized web page.

42. A system in accordance with claim 30, wherein:
said specialist follows up with said individual within a predetermined period of time after said first hyperlink to said personalized web page is communicated.

43. A system in accordance with claim 30, wherein:
agreement to a waiver by said individual is required prior to accessing said personalized web page.

44. A system in accordance with claim 30, wherein said personal need relates to at least one of child care, children with special needs, pet care, education, employee benefits, health care, children's health, diet and nutrition, employer policies and procedures, employer benefits, insurance, insurance claims, mental health, fitness, general health, men's health, safety and health, senior health, women's health, workplace health, elder care, pregnancy, prenatal care, legal services, finance, personal problem solving, or time management.

45. A system in accordance with claim 30, further comprising:
at least one of an informational database, an online search engine, or geographic mapping software adapted for use by said specialist in creating said personalized web page.

46. A system in accordance with claim 30, wherein:
said individual is one of an employee or a dependent of an employee; and
said specialist has access to an employer's human resource information regarding said employee.

47. A system in accordance with claim 46, wherein:
said specialist has access to said employer's Employee Assistance Provider (EAP) information.

48. A system in accordance with claim 47, wherein said referral information includes EAP information.

49. A system in accordance with claim 46, wherein:
utilization reports are provided to said employer regarding requests for assistance received.

50. A system in accordance with claim 46, wherein:
said personalized web page is updated to include at least one of:
status information regarding said request; or
employer personnel policy and benefits information relating to said personal need; and
a second hyperlink to said updated personalized web page is communicated to said individual.

51. A system in accordance with claim 50, wherein said status information includes at least one of status of a request for information, status of a claim relating to the personal need, status of a response to a request for benefits relating to said personal need, or status of a product order relating to said personal need.

52. A system in accordance with claim 50, wherein said employer personnel policy and benefits information includes at least one of a statement of corporate policy relating to said personal need, a description of the employee's health insurance plan, a description of the employee's dental insurance plan, a description of the employee's vision insurance plan, a description of the employer's Employee Assistance Program, a description of the employee's mental health insurance plan, a summary of authorization requirements for insurance plans, a description of the employee's retirement plan, or a description of the employer's financial programs.

53. A system in accordance with claim 30, wherein:
said individual is one of a care recipient, a care provider, or a beneficiary of a care recipient; and
said specialist has access to at least one of said care recipient's insurance information, said care recipient's medical records, said care recipient's employee benefits information, said care provider's policies and procedures, or said care provider's care program information.

54. A system in accordance with claim 30, wherein:
said individual is one of a customer or a service provider; and said specialist has access to said customer's service request records, said service provider's policies and procedures, or said service provider's service information.

55. A system in accordance with claim 30, wherein:
said educational materials are provided in the form of an online library.

56. A system in accordance with claim 30, wherein said educational materials comprise at least one of state regulations relating to said personal need, publications relating to said personal need, web pages relating to said personal need, product information relating to said personal need, Employee Assistance Provider information relating to said personal need, employee benefits information relating to said personal need, employer policy and procedural information relating to said personal need, insurance information relating to said personal need, claim information relating to said personal need, on-line seminar information, or decision support tools and calculators.

57. A system in accordance with claim 30, wherein:
said request for assistance comprises one of a telephone request or an online request.

58. A system in accordance with claim 30, wherein:
said request for assistance is made via telephone;
an operator verifies said individual's eligibility to access said specialist; and
an operator assigns said individual to a specialist based on said personal need.
